(19) United States
(12) Patent Application Publication
(10) Pub. No.: US 2022/0394915 A1
(43) Pub. Date: Dec. 15, 2022

(54) TRACTOR

(71) Applicant: TOYOTA JIDOSHA KABUSHIKI KAISHA, Aichi-ken (JP)

(72) Inventors: Nobuyuki TANAKA, Toyota-shi (JP); Yuki SUGO, Toyota-shi (JP)

(21) Appl. No.: 17/732,433

(22) Filed: Apr. 28, 2022

(30) Foreign Application Priority Data
Jun. 9, 2021 (JP) 2021-096609

(51) Int. Cl. A01B 79/00; A01B 63/12; B60L 58/13; B60L 58/18

(52) U.S. Cl. CPC A01B 79/005; A01B 63/12; B60L 58/13; B60L 58/18

(57) ABSTRACT

When it is determined that a tractor is located in a farm field, a first handling process of performing a first treatment for handling an abnormality when a first condition has been satisfied and a second handling process of performing a second treatment for handling an abnormality when a second condition has been satisfied are performed. The first condition is a condition that is satisfied when the second condition has been satisfied and that is satisfied in some situations in which the second condition has not been satisfied.

### CROSS-REFERENCE TO RELATED APPLICATION

This application claims priority to Japanese Patent Application No. 2021-096609 filed on Jun. 9, 2021, incorporated herein by reference in its entirety.

### BACKGROUND

### 1. Technical Field

The disclosure relates to a tractor

### 2. Description of Related Art

A tractor disclosed in Japanese Unexamined Patent Application Publication No. 2014-143965 (JP 2014-143965 A) includes a battery, an electric motor, and a rotary cultivator. The battery supplies electric power to the electric motor. The electric motor operates with electric power supplied from the battery. A driving force of the electric motor allows the tractor to travel or causes the rotary cultivator to operate. The tractor travels on a farm field such as a field of rice or another crop. By causing the rotary cultivator to operate at that time, it is possible to cultivate the farm field.

### SUMMARY

In the technique described in JP 2014-143965 A, when an abnormality occurs in an electrical system from the battery to the electric motor, a problem with travel of the tractor may occur. In general, a surface of a farm field is uneven or muddy. That is, a traveling environment in a farm field is poorer than a paved road. Accordingly, when a problem occurs in traveling of the tractor in the farm field and the tractor is no longer able to travel, handling which can be applied to a normal vehicle on a paved road such as performing traction cannot be employed. Accordingly, when an abnormality occurs in a farm field, it is necessary to withdraw the tractor from the farm field before the tractor is no longer able to travel.

According to an aspect of the disclosure, there is provided a tractor including: an electric motor configured to serve as a drive source; a vehicle body configured to be able to be connected to a working machine and that travels with a driving force from the electric motor; a battery configured to supply electric power to the electric motor; and an abnormality detection device configured to detect an abnormality of an electrical system between the battery and the electric motor. The abnormality detection device is configured to perform: a determination process of determining whether the vehicle body is located in a farm field; a first handling process of performing a first treatment for handling the abnormality when it is determined in the determination process that the vehicle body is located in the farm field and a predetermined first condition has been satisfied; and a second handling process of performing a second treatment different from the first treatment as a treatment for handling the abnormality when it is determined in the determination process that the vehicle body is located in the farm field and a predetermined second condition has been satisfied as a condition indicating occurrence of the abnormality. The first condition is a condition that is satisfied when the second condition has been satisfied and that is satisfied in some situations in which the second condition has not been satisfied.

With this configuration, the first condition is a condition which is more lenient than the second condition, and the first condition is more likely to be satisfied than the second condition. Accordingly, the first treatment can be performed when there is a doubt about an abnormality, and then the second treatment can be performed when there is a high likelihood that the abnormality is occurring. That is, with this configuration, occurrence of an abnormality is monitored in two stages and different treatments are performed in the stages. By performing the first treatment in the stage before an abnormality occurs, it is possible to urge an occupant of the tractor or the like to withdraw the tractor from the farm field.

The tractor may further include: a notification device configured to perform notification using at least one of light and sound; the working machine connected to the vehicle body; and a lifting mechanism configured to lift and lower the working machine. The abnormality detection device may be configured to control the lifting mechanism such that the lifting mechanism is in one of a lowered state in which the working machine is located at a position in contact with a ground surface and a lifted state in which the working machine is located at a position separated from the ground surface. The abnormality detection device may be configured to cause the notification device to notify of occurrence of the abnormality as the first treatment and to cause the working machine to be switched to a stopped state and the lifting mechanism to be switched to the lifted state as the second treatment.

With this configuration, by notifying of occurrence of an abnormality as the first treatment, an occupant can be notified at an earlier stage that there is a likelihood that the abnormality is occurring. By switching the working machine to the stopped state as the second treatment, power consumption of the battery with subsequent operation of the working machine can be curbed. By switching the lifting mechanism to the lifted state, the tractor is not braked due to the working machine in contact with a road surface in traveling of the tractor thereafter. Accordingly, with this configuration, it is possible to prevent the tractor from no longer being able to travel while in a farm field due to capacity deficiency of the battery before the tractor is withdrawn from the farm field.

The tractor may further include a notification device configured to perform notification using at least one of light and sound. The abnormality detection device may be configured to cause the notification device to notify of occurrence of the abnormality as the first treatment, and as the second treatment, to cause an output of the battery to be limited to less than the output of the battery in a state in which the second treatment has not been performed.

With this configuration, by notifying of occurrence of an abnormality as the first treatment, an occupant can be notified at an earlier stage that there is a likelihood that the abnormality is occurring. By limiting an output from the battery as the second treatment, power consumption of the battery can be curbed. By performing these treatments, it is possible to prevent the tractor from no longer being able to travel while in a farm field due to capacity deficiency of the battery before the tractor is withdrawn from the farm field.

In the tractor, the abnormality detection device may be configured to store necessary electric power which is electric power per unit time required for moving over a boundary between the farm field and a road near the farm field from the farm field to the road in advance. The abnormality detection device may be configured to limit the necessary electric power to an upper limit of electric power which is able to be output from the battery per unit time as the second treatment.

With this configuration, electric power required for movement from the farm field to a road is secured even when the second treatment is performed. That is, with this configuration, the tractor can be reliably withdrawn from the farm field even when the farm field is located lower than a nearby road such as a rice paddy.

In the tractor, the abnormality detection device may be configured to prohibit execution of the second treatment when a travel speed of the vehicle body is equal to or lower than a prescribed vehicle speed. When the surface of the farm field has a large degree of unevenness and a large degree of muddiness, movement of the tractor becomes slower. In such a situation with a poor traveling environment on the farm field, a larger driving force is necessary. Therefore, with this configuration, in a situation in which a traveling speed of the tractor is low and the traveling environment of the farm field is expected to be poor, limiting of the output is prohibited. Accordingly, even when the traveling environment of the farm field is poor, it is possible to preferentially perform travel of the tractor.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a side view of a tractor;

FIG. 2 is a diagram illustrating an electrical configuration and a power transmission path of the tractor;

FIG. 3 is a diagram illustrating details of a first treatment and a second treatment; and

FIG. 4 is a flowchart illustrating a routine of an abnormality handling process.

### DETAILED DESCRIPTION OF EMBODIMENTS

Hereinafter, a tractor according to an embodiment will be described with reference to the accompanying drawings.

Entire Configuration of Tractor

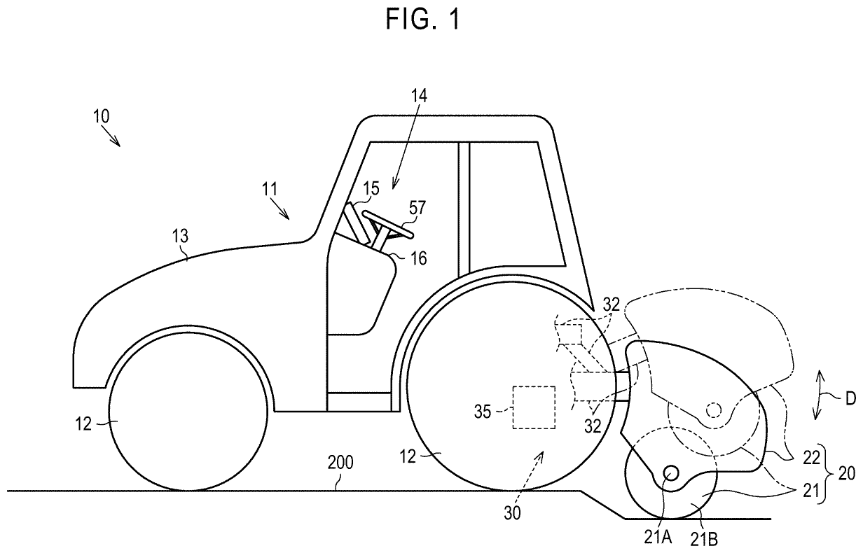

As illustrated in FIG. 1, a tractor 10 includes a vehicle 11. The vehicle 11 includes a vehicle body 13 and a plurality of wheels 12. The plurality of wheels 12 is connected to the vehicle body 13. The vehicle body 13 includes a cabin 14. The cabin 14 is a space which is partitioned in the vehicle body 13. The cabin 14 is a control compartment that an occupant boards.

The vehicle 11 includes a console 16 and a display 15. The console 16 is located in the cabin 14. The display 15 is located on the console 16. The display 15 can display various types of information. That is, the display 15 is a notification device that notifies of various types of information using light.

The tractor 10 includes a working machine 20. The working machine 20 is located in the back of the vehicle 11. The working machine 20 includes a support member 22 and a rotary member 21. The support member 22 is connected to the vehicle body 13 via a lifting mechanism 30 which will be described later. The rotary member 21 includes a rotation shaft 21A and a plurality of blades 21B. The rotation shaft 21A is rotatably supported by the support member 22. The plurality of blades 21B rotates with the rotation shaft 21A. In FIG. 1, the blades 21B are simply illustrated in a cylindrical shape. When the rotation shaft 21A rotates in a state in which the blades 21B are in contact with a ground surface 200 of a farm field, the farm field can be cultivated.

The tractor 10 includes a lifting mechanism 30. The lifting mechanism 30 includes a plurality of arms 32 and a hydraulic device 35. The plurality of arms 32 is connected to each other. The plurality of arms 32 connects the vehicle body 13 and the support member 22 of the working machine 20. The hydraulic device 35 generates a hydraulic pressure. The arms 32 operate with the hydraulic pressure. As a result, the working machine 20 is lifted or lowered as indicated by an arrow D in FIG. 1. At the same time, the rotary member 21 of the working machine 20 comes into contact with the ground surface 200 or is separated from the ground surface 200. In the following description, a state of the lifting mechanism 30 for switching the rotary member 21 of the working machine 20 to a position at which it is in contact with the ground surface 200 is referred to as a lowered state. A state of the lifting mechanism 30 for switching the rotary member 21 to a position at which it is separated from the ground surface 200 is referred to as a lifted state. In FIG. 1, a position of the working machine 20 when the lifting mechanism 30 is in the lowered state is indicated by a solid line. In FIG. 1, a position of the working machine 20 when the lifting mechanism 30 is in the lifted state is indicated by a two-dot chain line.

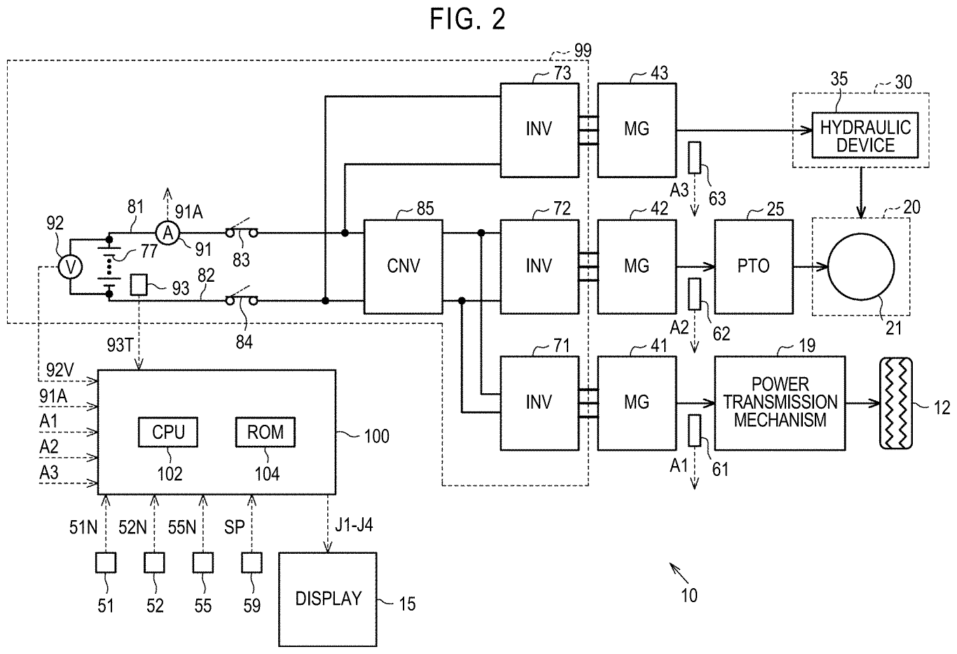

As illustrated in FIG. 2, the tractor 10 includes a vehicle speed sensor 59. The vehicle speed sensor 59 detects a travel speed of the vehicle 11 as a vehicle speed SP. The tractor 10 includes a plurality of switches and levers as an operation unit. The plurality of switches and levers is used for an occupant to change the travel speed of the tractor 10 or for an occupant to operate the working machine 20 and the lifting mechanism 30. One of the plurality of switches is a start switch 55 for instructing start of the tractor 10. One of the plurality of switches is a position information switch 51 which is turned on or off by an occupant depending on whether the tractor 10 is located in a farm field. One of the plurality of switches is a reset switch 52 for deleting display on the display 15 based on an abnormality handling process which will be described later. The start switch 55, the position information switch 51, and the reset switch 52 are provided, for example, on the console 16. As illustrated in FIG. 1, the vehicle 11 includes a steering wheel 57.

Power Transmission Path of Tractor

As illustrated in FIG. 2, the tractor 10 includes a first electric motor 41, a second electric motor 42, a third electric motor 43, a power transmission mechanism 19, and a PTO 25. The first electric motor 41, the second electric motor 42, and the third electric motor 43 are generator motors.

The first electric motor 41 is a drive source for allowing the tractor 10 to travel. The first electric motor 41 is connected to the wheels 12 via the power transmission mechanism 19. The power transmission mechanism 19 includes, for example, a reduction gear mechanism that amplifies and outputs a torque.

The second electric motor 42 is a drive source of the working machine 20. The second electric motor 42 is connected to the rotary member 21 of the working machine 20 via the PTO 25. The PTO 25 is a device that transmits a torque of the second electric motor 42 to the rotary member 21. The PTO 25 includes, for example, a reduction gear mechanism.

The third electric motor 43 is a drive source of the hydraulic device 35. The third electric motor 43 is connected to a hydraulic pump of the hydraulic device 35. The third electric motor 43 drives the hydraulic pump. As described above, the first electric motor 41, the second electric motor 42, and the third electric motor 43 are generator motors. Accordingly, these electric motors can serve as generators. For example, the first electric motor 41 can serve as a power generator when the tractor 10 decelerates. At that time, a regenerative braking force based on an amount of electric power generated by the first electric motor 41 is generated in the tractor 10.

The tractor 10 includes a first rotation sensor 61, a second rotation sensor 62, and a third rotation sensor 63. The first rotation sensor 61 detects a rotational position of a rotor of the first electric motor 41 as a first position A1. The second rotation sensor 62 detects a rotational position of a rotor of the second electric motor 42 as a second position A2. The third rotation sensor 63 detects a rotational position of a rotor of the third electric motor 43 as a third position A3.

Electrical Configuration of Tractor

As illustrated in FIG. 2, the tractor 10 includes a power supply circuit 99. The power supply circuit 99 is mounted in the vehicle body 13. The power supply circuit 99 includes a battery 77, a positive electrode line 81, a negative electrode line 82, a positive electrode relay 83, and a negative electrode relay 84. The power supply circuit 99 includes a first converter 85, a first inverter 71, a second inverter 72, and a third inverter 73. The power supply circuit 99 includes a current sensor 91, a voltage sensor 92, and a temperature sensor 93.

The battery 77 is a secondary battery. The battery 77 transmits and receives electric power to and from the first electric motor 41, the second electric motor 42, and the third electric motor 43. The voltage sensor 92 is connected between terminals of the battery 77. The voltage sensor 92 detects an output voltage of the battery 77 as a battery voltage 92V. The temperature sensor 93 is attached to the battery 77. The temperature sensor 93 detects the temperature of the battery 77 as a battery temperature 93T.

The positive electrode line 81 connects a high-potential terminal of the battery 77 to the first converter 85. The negative electrode line 82 connects a low-potential terminal of the battery 77 to the first converter 85. The first converter 85 converts and outputs the magnitude of a voltage.

The positive electrode relay 83 is provided in the middle of the positive electrode line 81. The negative electrode relay 84 is provided in the middle of the negative electrode line 82. The positive electrode relay 83 and the negative electrode relay 84 turn on or off electrical connection between the battery 77 and the first converter 85.

The current sensor 91 is provided in the middle of the positive electrode line 81. Specifically, the current sensor 91 is provided between the battery 77 and the positive electrode relay 83 on the positive electrode line 81. The current sensor 91 detects a charging/discharging current flowing in the battery 77 as a battery current 91A.

The first inverter 71 and the second inverter 72 are connected to the first converter 85. The first inverter 71 and the second inverter 72 are connected in parallel. The first inverter 71 is connected to the first electric motor 41. The first inverter 71 performs AC/DC electric power conversion between the first converter 85 and the first electric motor 41. The second inverter 72 is connected to the second electric motor 42. The second inverter 72 performs AC/DC electric power conversion between the first converter 85 and the second electric motor 42.

The third inverter 73 is connected to the battery 77. The third inverter 73 is connected in parallel to the first converter 85. The third inverter 73 is connected to the third electric motor 43. The third inverter 73 performs AC/DC electric power conversion between the battery 77 and the third electric motor 43.

Configuration of Control Device

The tractor 10 includes a control device 100. The control device 100 can be constituted by one or more processors that perform various processes in accordance with a computer program (software). The control device 100 may be configured as circuitry including one or more dedicated hardware such as an application-specific integrated circuit (ASIC) that performs at least some processes of the various processes or a combination thereof. The processor includes a CPU 102 and memories such as a RAM and a ROM 104. The memories store program codes or commands configured to cause the CPU 102 to perform processing. The memories, that is, computer-readable media, include all available media that can be accessed by a general-purpose or dedicated computer. The control device 100 includes a storage device which is an electrically rewritable nonvolatile memory.

The control device 100 receives signals from various operation units. That is, the control device 100 receives a signal 55N from the start switch 55. The control device 100 receives a signal 51N from the position information switch 51. The control device 100 receives a signal 52N from the reset switch 52.

The control device 100 receives detection signals from various sensors. The control device 100 receives the vehicle speed SP detected by the vehicle speed sensor 59. The control device 100 receives the battery current 91A detected by the current sensor 91. The control device 100 receives the battery voltage 92V detected by the voltage sensor 92. The control device 100 receives the battery temperature 93T detected by the temperature sensor 93. The control device 100 calculates a state of charge SOC of the battery 77 based on the battery current 91A, the battery voltage 92V, and the battery temperature 93T. The state of charge SOC of the battery 77 is a value obtained by dividing a residual capacity of the battery 77 by a fully charged capacity thereof.

The control device 100 receives the first position A1 detected by the first rotation sensor 61, the second position A2 detected by the second rotation sensor 62, and the third position A3 detected by the third rotation sensor 63. The control device 100 calculates a first rotation speed Smg1 which is a rotation speed of the rotor of the first electric motor 41 based on the first position A1. Similarly, the control device 100 calculates a second rotation speed Smg2 which is a rotation speed of the rotor of the second electric motor 42 based on the second position A2. Similarly, the control device 100 calculates a third rotation speed Smg3 which is a rotation speed of the rotor of the third electric motor 43 based on the third position A3.

The control device 100 controls the first electric motor 41 as a control target. The control device 100 causes the tractor 10 to travel or stops traveling of the tractor 10 by controlling the first electric motor 41. Substantially, the control device 100 controls the first electric motor 41 by controlling the first inverter 71. The control device 100 controls the first electric motor 41 with reference to the first rotation speed Smg1. The control device 100 stores a plurality of predetermined target travel speeds. For example, the control device 100 controls the first electric motor 41 based on one of the plurality of target travel speeds in accordance with an instruction from an occupant.

The control device 100 controls the working machine 20 as a control target. Specifically, the control device 100 controls the working machine 20 by controlling the second electric motor 42. That is, the control device 100 causes the rotary member 21 to rotate or stops rotating of the rotary member 21 by controlling the second electric motor 42. Substantially, the control device 100 controls the second electric motor 42 by controlling the second inverter 72. The control device 100 controls the second electric motor 42 with reference to the second rotation speed Smg2. For example, the control device 100 causes the rotary member 21 to rotate or stops rotating of the rotary member 21 in accordance with an instruction from an occupant.

The control device 100 controls the lifting mechanism 30 as a control target. Specifically, the control device 100 controls a hydraulic pressure generated by the hydraulic device 35 by controlling the third electric motor 43, a control valve of a flow passage in the hydraulic device 35, and the like. As a result, the lifting mechanism 30 is switched to the lifted state or the lowered state. Substantially, the control device 100 controls the third electric motor 43 by controlling the third inverter 73. The control device 100 controls the third electric motor 43 with reference to the third rotation speed Smg3. For example, the control device 100 switches the lifting mechanism 30 to the lifted state or the lowered state in accordance with an instruction from an occupant.

The control device 100 controls the display 15 as a control target. The control device 100 outputs a display signal for displaying various types of information on the display 15 to the display 15. When the display signal is received, the display 15 displays details corresponding to the display signal.

The control device 100 controls the positive electrode relay 83 and the negative electrode relay 84 as a control target. That is, the control device 100 switches electrical connection in the positive electrode relay 83 and the negative electrode relay 84 between on and off according to turning-on/off of the start switch 55.

Function of Abnormality Detection Device

The control device 100 functions as an abnormality detection device that detects an abnormality in an electrical system between the battery 77 and the first electric motor 41. As described above, the electrical system between the battery 77 and the first electric motor 41 includes the battery 77, the positive electrode line 81, the negative electrode line 82, the positive electrode relay 83, the negative electrode relay 84, the first converter 85, the first inverter 71, and the first electric motor 41. In this embodiment, the control device 100 detects an abnormality of the battery 77 as an abnormality of the electrical system between the battery 77 and the first electric motor 41. An abnormality of the battery 77 mentioned herein does not mean a defective state in which electric power cannot be supplied from the battery 77 to the first electric motor 41, but means an abnormality in a range in which electric power can be supplied from the battery 77 to the first electric motor 41. That is, a state in which electric power is being supplied from the battery 77 to the first electric motor 41, the tractor 10 can travel, and the battery 77 cannot be said to be completely normal is defined as the abnormality of the battery 77.

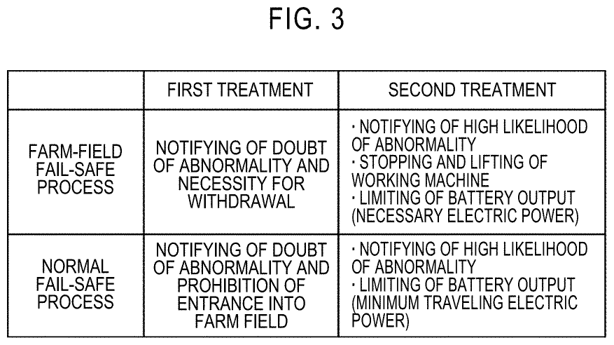

The control device 100 can perform a fail-safe process as a part of the function of the abnormality detection device. The fail-safe process is a process of detecting an abnormality of the battery 77 or a sign thereof and handling the abnormality. As illustrated in FIG. 3, the fail-safe process includes a farm-field fail-safe process and a normal fail-safe process. The farm-field fail-safe process is performed when the tractor 10 is located in a farm field. The normal fail-safe process is performed when the tractor 10 is located outside of a farm field, that is, when the tractor 10 is traveling on a paved road.

Farm-Field Fail-Safe Process

In the farm-field fail-safe process, the control device 100 performs a first treatment for a farm field as a treatment for handling an abnormality of the battery 77 when a predetermined first condition has been satisfied. As illustrated in FIG. 3, the first treatment for a farm field is a treatment of displaying a first message on the display 15. Details of the first message include information indicating that there is a doubt of occurrence of an abnormality in the battery 77 (hereinafter simply referred to as a doubt about an abnormality) and information indicating that the tractor 10 needs to withdraw from the farm field. That is, in the first treatment for a farm field, a sign of an abnormality of the battery 77 such as a doubt about an abnormality is handled. In the first treatment according to this embodiment, it is possible to handle an abnormality before the abnormality becomes serious by handling a sign of an abnormality of the battery 77. The process of performing the first treatment is a first handling process in the farm-field fail-safe process.

The control device 100 stores a first condition in advance. The first condition is a condition that the state of charge SOC of the battery 77 is equal to or less than a first value L1. The first value L1 is, for example, 20 [%]. The first value L1 is determined in advance as the following value, for example, by experiment or simulation. That is, the first value L1 is a value of the state of charge SOC of the battery 77 at which the battery 77 is still normal but there is a high likelihood that irreversible deterioration is occurring in the battery 77 due to over-discharging or the like when electric power is continuously output from the battery 77 in the current situation.

In the farm-field fail-safe process, the control device 100 performs a second treatment for a farm field as a treatment for handling an abnormality of the battery 77 when a predetermined second condition is satisfied. As illustrated in FIG. 3, the second treatment for a farm field includes the three following treatments. One of the second treatment for a farm field is to display a second message on the display 15.

Details of the second message include information indicating that there is a high likelihood that an abnormality is occurring in the battery 77. One of the second treatment for a farm field is to switch the working machine 20 to a stopped state and to switch the lifting mechanism 30 to the lifted state. One of the second treatment for a farm field is to limit an output of the battery 77 such that it is less than the output of the battery 77 in a state in which the second treatment has not been performed. Limiting of the output of the battery 77 will be described later in detail. The process of performing the second treatment is a second handling process of the farm-field fail-safe process.

The control device 100 stores a second condition in advance. The second condition is determined in advance as a condition indicating occurrence of an abnormality in the battery 77. The second condition is a condition that the state of charge SOC of the battery 77 is equal to or less than a second value L2. The second value L2 is a value less than the first value L1 and is, for example, 5 [%]. The second value L2 is determined as a value at which the output voltage of the battery 77 is much lower than a rated output voltage and there is a very high likelihood that an abnormality is occurring in the battery 77 such as overheating of the battery 77, for example, by experiment or simulation. As can be seen from a result of comparison between the second condition and the first condition, the first condition is a condition that is satisfied when the second condition has been satisfied and that is satisfied in some situations in which the second condition has not been satisfied.

Limiting of the output of the battery 77 will be described below. Limiting of the output of the battery 77 is specifically to limit an upper limit of electric power which can be output from the battery 77 per unit time. That is, the control device 100 sets an output upper limit Wout as an upper limit of a total amount of electric power which can be output from the battery 77 per unit time as the second treatment. The control device 100 controls the first electric motor 41, the second electric motor 42, and the third electric motor 43 such that electric power output from the battery 77 does not exceed the output upper limit Wout.

The control device 100 stores the output upper limit Wout associated with the second treatment in advance. For example, a farm field such as a field for rice is located at a position lower than a nearby road surface. A slope for entrance and exit of the farm field is provided in a boundary between the farm field and the road surface. Electric power per unit time necessary for movement over the slope from the farm field to the road surface is referred to as necessary electric power. The control device 100 stores the necessary electric power as the output upper limit Wout associated with the second treatment. The necessary electric power is determined, for example, by experiment or simulation. A slope angle of the slope differs depending on a farm field. Here, a maximum value of the slope angle of the slope of the farm field is referred to as a maximum slope angle. The maximum slope angle is assumed to be as the slope angle of the slope when the necessary electric power is set.

When the vehicle speed SP of the tractor 10 is equal to or less than a prescribed vehicle speed SPK, the control device 100 prohibits limiting of the output of the battery 77. That is, when the vehicle speed SP of the tractor 10 is equal to or less than the prescribed vehicle speed SPK, the control device 100 does not perform limiting of the output of the battery 77 even when the second condition has been satisfied. In general, a surface of a farm field has, for example, a large degree of unevenness and a large degree of muddiness and thus a traveling environment therein is poor. When the tractor 10 travels in such an environment, the vehicle speed SP of the tractor 10 is likely to be low. When the tractor 10 travels in such an environment, a considerably large driving force is required for the tractor 10 and supply of electric power from the battery 77 which is sufficient for outputting the driving force is required. Therefore, limiting of the output of the battery 77 is prohibited when the vehicle speed SP of the tractor 10 is very low such that electric power sufficient for allowing the tractor 10 to travel in the environment can be supplied.

The prescribed vehicle speed SPK is determined in advance as a maximum value of the vehicle speed SP of the tractor 10 when it is estimated that the traveling environment in the farm field is poor, for example, by experiment or simulation. For example, the prescribed vehicle speed SPK ranges from 1 km/h to 3 km/h.

Normal Fail-Safe Process

In the normal fail-safe process, the control device 100 performs a normal first treatment for handling an abnormality of the battery 77 when the first condition is satisfied. As illustrated in FIG. 3, the normal first treatment is to display a third message on the display 15. Details of the third message include information indicating that there is a doubt about an abnormality of the battery 77 and information indicating that entrance into the farm field is prohibited. In the normal fail-safe process, the control device 100 performs a normal second treatment for handling an abnormality of the battery 77 when the second condition is satisfied. The normal second treatment includes the two following treatments. One of the normal second treatments is to display a fourth message on the display 15. Details of the fourth message include information indicating that there is a high likelihood that an abnormality is occurring in the battery 77. One of the normal second treatments is to limit the output of the battery 77. The control device 100 stores the output upper limit Wout associated with the normal second treatment in advance. When it is assumed that the tractor 10 is traveling on a paved road, electric power per unit time necessary for allowing the tractor 10 to travel at a minimum value out of the plurality of target travel speeds set for the tractor 10 is referred to as minimum traveling electric power. The control device 100 stores the minimum traveling electric power as the output upper limit Wout of the battery 77 associated with the normal second treatment. The minimum traveling electric power is determined, for example, by experiment or simulation. The minimum traveling electric power is lower than the necessary electric power.

Abnormality Handing Process

The control device 100 can perform an abnormality handling process as a comprehensive process for performing the farm-field fail-safe process and the normal fail-safe process. The control device 100 further performs a determination process in addition to the farm-field fail-safe process and the normal fail-safe process as a part of the abnormality handling process. In the determination process, the control device 100 determines whether the tractor 10 is located in a farm field. When it is determined in the determination process that the tractor 10 is located in a farm field, the control device 100 performs the farm-field fail-safe process. When it is determined in the determination process that the tractor 10 is located outside of a farm field, the control device 100 performs the normal fail-safe process.

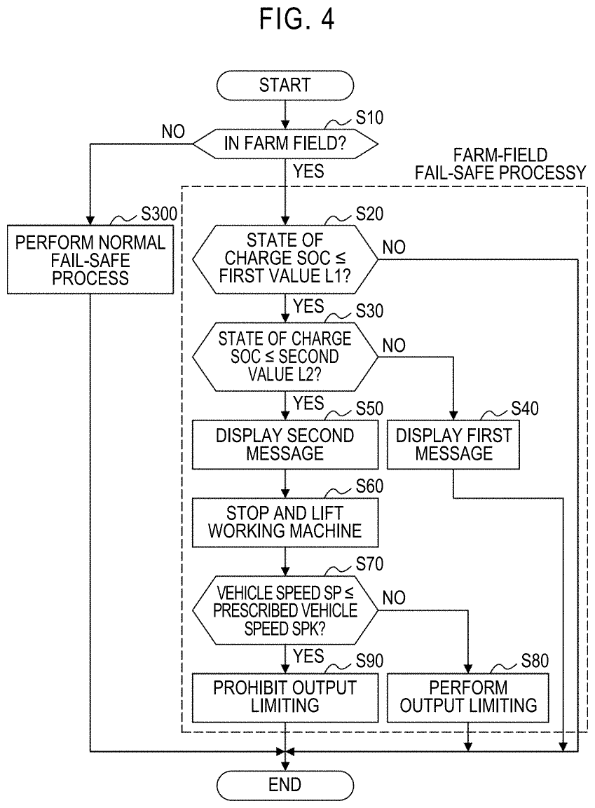

A specific routine of the abnormality handling process will be described below. The control device 100 repeatedly performs the abnormality handling process every predetermined control cycle while the start switch 55 is in the turned-on state. As illustrated in FIG. 4, when the abnormality handling process is started, first, the control device 100 performs the process of Step S10. In Step S10, the control device 100 determines whether the tractor 10 is located in a farm field. The control device 100 performs the determination of Step S10 based on the signal MN from the position information switch 51. When the signal MN indicating the turned-on state is received from the position information switch 51, the control device 100 determines that the tractor 10 is located in a farm field (Step S10: YES). In this case, the control device 100 causes the routine to proceed to Step S20. The process of Step S10 is a determination process.

In Step S20, the control device 100 determines whether the state of charge SOC of the battery 77 is equal to or less than the first value L1. Specifically, the control device 100 performs this determination with reference to the newest state of charge SOC. Then, the control device 100 compares the newest state of charge SOC with the first value L1 which is stored in advance. When the newest state of charge SOC is greater than the first value L1 (Step S20: NO), the control device 100 temporarily ends the routine of the abnormality handling process. In this case, the control device 100 performs the process of Step S10 again.

On the other hand, when it is determined in Step S20 that the newest state of charge SOC is equal to or less than the first value L1 (Step S20: YES), the control device 100 causes the routine to proceed to Step S30. In Step S30, the control device 100 determines whether the state of charge SOC of the battery 77 is equal to or less than the second value L2. Specifically, the control device 100 performs this determination with reference to the newest state of charge SOC. Then, the control device 100 compares the newest state of charge SOC with the second value L2 which is stored in advance. When the newest state of charge SOC is greater than the second value L2 (Step S30: NO), the control device 100 causes the routine to proceed to Step S40.

In Step S40, the control device 100 displays the first message on the display 15. As a specific process of Step S40, the control device 100 outputs a first display signal J1 to the display 15. The first display signal J1 is a signal for displaying information indicating that there is a doubt about an abnormality in the battery 77 and information indicating that the tractor 10 needs to withdraw from the farm field on the display 15. When the first display signal J1 is received, the display 15 displays a message corresponding to the first display signal J1. As described above, the messages for the fail-safe process include four types of messages of the first to fourth messages. Display signals for displaying such messages include four types of signals of first to fourth display signals J1 to J4. When a display signal for the fail-safe process other than the first display signal J1 is being output at a time point at which the process of Step S40 is performed, the control device 100 cancels outputting of the display signal and outputs the first display signal J1. When the first display signal J1 is being output at a time point at which the process of Step S40 is performed, the control device 100 continues to output the first display signal J1.

The process of Step S40 is a process of substantially starting output of the first display signal J1. In a process other than Step S40 of the abnormality handling process, the control device 100 continues to output the first display signal J1 when a display signal for the fail-safe process other than the first display signal J1 is output or until the reset switch 52 is operated. When the process of Step S40 is performed, the control device 100 temporarily ends the routine of the abnormality handling process. Then, the control device 100 performs the process of Step S10 again. The process of Step S40 is the first handling process.

On the other hand, when it is determined in Step S30 that the newest state of charge SOC is equal to or less than the second value L2 (Step S30: YES), the control device 100 causes the routine to proceed to Step S50. In Step S50, the control device 100 displays the second message on the display 15. As a specific process of Step S50, the control device 100 outputs the second display signal J2 to the display 15. The second display signal J2 is a display signal for displaying information indicating that there is a high likelihood that an abnormality is occurring in the battery 77, information indicating that the tractor 10 needs to withdraw from the farm field, and information indicating that appropriate necessary processes are performed on the corresponding units of the tractor 10 on the display 15. The necessary processes specifically include a process of stopping the working machine 20, a process of switching the lifting mechanism 30 to the lifted state, and a process of limiting the output of the battery 77 depending on a situation. When another display signal for the fail-safe process is output at the time point at which the process of Step S50 is performed as in Step S40, the control device 100 cancels outputting of the display signal and outputs the second display signal J2. When the second display signal J2 is being output at the time point at which the process of Step S50 is performed, the control device 100 continues to output the second display signal J2. Similarly to the process of Step S40, the process of Step S50 is a process of substantially starting outputting of the second display signal J2. As in the first display signal J1, the control device 100 continues to output the second display signal J2 when a display signal for the fail-safe process other than the second display signal J2 is output or until the reset switch 52 is operated. When the process of Step S50 has been performed, the control device 100 causes the routine to proceed to Step S60.

In Step S60, the control device 100 switches the rotary member 21 of the working machine 20 to the stopped state by controlling the second electric motor 42. That is, the control device 100 stops the second electric motor 42. When the rotary member 21 has already fallen into the stopped state at the time point at which the process of Step S60 is performed, the control device 100 maintains this state. In Step S60, the control device 100 switches the lifting mechanism 30 to the lifted state by controlling the third electric motor 43, the hydraulic circuit, and the like. When the lifting mechanism 30 has already fallen into the lifted state at the time point at which the process of Step S60 is performed, the control device 100 maintains this state. When the process of Step S60 has been performed, the control device 100 causes the routine to proceed to Step S70.

In Step S70, the control device 100 determines whether the vehicle speed SP is equal to or less than the prescribed vehicle speed SPK. The control device 100 performs this determination with reference to a newest vehicle speed SP. Then, the control device 100 compares the newest vehicle speed SP with the prescribed vehicle speed SPK which is stored in advance. When the newest vehicle speed SP is higher than the prescribed vehicle speed SPK (Step S70: NO), the control device 100 causes the routine to proceed to Step S80.

In Step S80, the control device 100 limits the output of the battery 77. That is, the control device 100 sets the output upper limit Wout of the battery 77 to the necessary electric power. When the output upper limit Wout has been already set to the necessary electric power at the time point at which the process of Step S80 is performed, the control device 100 maintains this state. When the process of Step S80 has been performed, the control device 100 temporarily ends the routine of the abnormality handling process. The control device 100 performs the process of Step S10 again.

On the other hand, when it is determined in Step S70 that the newest vehicle speed SP is equal to or less than the prescribed vehicle speed SPK (Step S70: YES), the control device 100 causes the routine to proceed to Step S90. In Step S90, the control device 100 prohibits limiting of the output of the battery 77. Specifically, when the output of the battery 77 has been already limited at the time point at which the process of Step S90 is performed, the control device 100 cancels limiting of the output. That is, the control device 100 releases setting of the output upper limit Wout. When the output of the battery 77 has not been limited at the time point at which the process of Step S90 is performed, the control device 100 maintains this state. When the process of Step S90 has been performed, the control device 100 temporarily ends the routine of the abnormality handling process. Then, the control device 100 performs the process of Step S10 again. The processes of Steps S50, S60, and S80 correspond to the second handling process. The processes of Steps S20 to S90 correspond to the farm-field fail-safe process.

When it is determined in Step S10 that the signal 51N indicating the turned-on state is not received from the position information switch 51 the control device 100 determines that the tractor 10 is not located in a farm field (Step S10: NO). In this case, the control device 100 causes the routine to proceed to Step S300.

In Step S300, the control device 100 performs the normal fail-safe process. That is, when the newest state of charge SOC of the battery 77 is equal to or less than the first value L1 and the newest state of charge SOC is greater than the second value L2, the control device 100 displays the third message on the display 15 as the normal first treatment. The control device 100 substantially outputs the third display signal J3 to the display 15. The third display signal J3 is a display signal for displaying information indicating that there is a doubt about an abnormality of the battery 77 and information indicating that entrance into the farm field is prohibited on the display 15. The control device 100 starts outputting of the third display signal J3 or continues to output the third display signal J3 in the same way as outputting of the first display signal J1 described above in Step S40.

In Step S300, the control device 100 limits the output of the battery 77 as the normal second treatment when the newest state of charge SOC of the battery 77 is equal to or less than the second value L2. The control device 100 substantially sets the output upper limit Wout of the battery 77 as the minimum traveling electric power. The control device 100 displays the fourth message on the display 15. The control device 100 substantially outputs the fourth display signal J4 to the display 15. The fourth display signal J4 is a display signal for displaying information indicating that there is a high likelihood that an abnormality is occurring in the battery 77, information indicating that entrance into the farm field is prohibited, and information indicating that the output of the battery 77 is limited on the display 15. In the normal second treatment, the control device 100 starts limiting of the output of the battery 77 or continues to limit the output of the battery 77 in the same way as limiting of the output of the battery 77 described above in

Step S80. The control device 100 starts outputting of the fourth display signal J4 or continues to output the fourth display signal J4 in the same way as in outputting of the first display signal J1 described above in Step S40. When the process of Step S300 has been performed, the control device 100 temporarily ends the routine of the abnormality handling process. Then, the control device 100 performs the process of Step S10 again.

Operation of Embodiment

It is assumed that the tractor 10 is located in a farm field (Step S10: YES). The tractor 10 is cultivating the farm field. That is, the lifting mechanism 30 is in the lowered state. The working machine 20 is operating.

it is assumed that the state of charge SOC of the battery 77 has decreased for some reasons. It is assumed that the state of charge SOC of the battery 77 is equal to or less than the first value L1 (Step S20: YES) and greater than the second value L2 (Step S30: NO). In this case, the control device 100 displays the first message on the display 15 as the first treatment for a farm field (Step S40).

Thereafter, it is assumed that an occupant having ascertained the display on the display 15 causes the tractor 10 to withdraw from the farm field and the state of charge SOC of the battery 77 becomes equal to or less than the second value L2 before withdrawal from the farm field is completed (Step S30: YES). In this case, as the second treatment for a farm field, the control device 100 switches the first message displayed on the display 15 up to that time to the second message (Step S50). The control device 100 forcibly stops the working machine 20 and forcibly switches the lifting mechanism 30 to the lifted state (Step S60). The control device 100 limits the output of the battery 77 only when the vehicle speed SP is higher than the prescribed vehicle speed SPK (Step S80). That is, the control device 100 sets the output upper limit Wout of the battery 77 as the necessary electric power. By stopping the working machine 20 and the limiting the output of the battery 77, the tractor 10 can travel while curbing power consumption from the battery 77. Since the output upper limit Wout of the battery 77 is the necessary electric power, the tractor 10 can fully ascend over the slope which is the boundary between the farm field and the nearby road.

Thereafter, it is assumed that the tractor 10 completes withdrawal from the farm field (Step S10: NO). Accordingly, it is assumed that an occupant turns off the position information switch 51 therewith. At this time, since the state of charge SOC of the battery 77 is kept equal to or less than the second value L2, the control device 100 performs the normal second treatment (Step S300). That is, the control device 100 switches the second message displayed on the display 15 up to that time to the fourth message. The control device 100 sets the output upper limit Wout as the minimum traveling electric power less than the necessary electric power. The tractor 10 travels in a state in which power consumption from the battery 77 has been further curbed and stops, for example, on a roadside.

### Advantages of Embodiment

(1) In this embodiment, the first condition is a condition that is more lenient than the second condition, and the first condition is more likely to be satisfied than the second condition. Accordingly, in the abnormality handling process, the first treatment is performed when there is a doubt about an abnormality of the battery 77, and then the second treatment is performed when there is a high likelihood that an abnormality is occurring in the battery 77. In this embodiment, occurrence of an abnormality is monitored in two stages in this way and different treatments are performed in the stages. In the first treatment which is a treatment of the first stage when the tractor 10 is located in the farm field, a doubt about an abnormality of the battery 77 is notified. By performing the first treatment in the stage before an abnormality of the battery 77 occurs, it is possible to urge an occupant of the tractor 10 to withdraw the tractor 10 from the farm field before the abnormality of the battery 77 becomes serious.

(2) In this embodiment, as the second treatment when the tractor 10 is located in the farm field, the working machine 20 is switched to the stopped and the lifting mechanism 30 is switched to the lifted state. When the working machine 20 is switched to the stopped state, power consumption of the battery 77 with subsequent operation of the working machine 20 can be curbed. When the lifting mechanism 30 is switched to the lifted state, the tractor 10 is not braked due to contact of the rotary member 21 of the working machine 20 with a road surface in traveling of the tractor 10 thereafter. Accordingly, according to this embodiment, it is possible to prevent the tractor 10 from being no longer able to travel on the farm field due to capacity deficiency of the battery 77 before the tractor 10 withdraws from the farm field.

(3) In this embodiment, the output of the battery 77 is limited as the second treatment when the tractor 10 is located in the farm field. When the output of the battery 77 is limited, it is possible to curb subsequent power consumption of the battery 77. By limiting the output of the battery 77 as well as stopping the working machine 20, it is possible to more reliably prevent the tractor 10 from being no longer able to travel on the farm field due to capacity deficiency of the battery 77.

(4) In this embodiment, as described above in (3), the output upper limit Wout in limiting the output of the battery 77 is set as the necessary electric power which is electric power necessary for movement on a slope from the farm field to a nearby road. Accordingly, it is possible to secure electric power necessary for movement from the farm field to a road even when the output of the battery 77 is limited. Accordingly, it is possible to reliably enable the tractor 10 to withdraw from the farm field even when the farm field is located lower than the nearby road such as a field for rice.

(5) Regarding the second treatment which is performed when the tractor 10 is located in a farm field, according to this embodiment, when the vehicle speed SP is equal to or lower than the prescribed vehicle speed SPK, that is, when the traveling environment of the farm field is expected to be poor and a large driving force is necessary, limiting of the output of the battery 77 is prohibited. Accordingly, even when the traveling environment of the farm field is poor, it is possible to enable the tractor 10 to travel.

### MODIFIED EXAMPLES

This embodiment can be modified as follows. The embodiment and the following modified examples can be combined unless technical conflictions arise.

Limiting of the output of the battery 77 according to the magnitude of the vehicle speed SP may not be prohibited. For example, when electric power set as the output upper limit Wout is sufficiently large, it is possible to output a driving force required for traveling without limiting the output of the battery 77.

The method of defining the necessary electric power is not limited to the example described in the embodiment. For example, the necessary electric power may not be a general value which is applicable to various farm fields, but may be electric power necessary for ascent of a slope of a specific farm field. When the farm field cultivated by the tractor 10 is limited to a specific farm field, necessary electric power for the farm field can be determined. Electric power necessary for ascent of a slope of a specific farm field can be ascertained, for example, from necessary electric power when the tractor ascended the slope in the past.

The necessary electric power may not consider traveling on a slope between a farm field and a nearby road. For example, a boundary between a farm field and a nearby road may be stepped depending on the farm field. In this case, electric power necessary for going over the stepped portion can be determined as the necessary electric power. When there is not slope and stepped portion between a farm field and a nearby road, the necessary electric power may be the same as the minimum traveling electric power. In this way, the necessary electric power may be electric power necessary for movement over a boundary between a farm field and a nearby road from the farm field to the road.

The necessary electric power may be determined without calculating electric power actually necessary for movement from a farm field to a road by simulation or the like. For example, the necessary electric power may be determined as an electric power value greater by a predetermined value than the minimum traveling electric power or an electric power value greater by a predetermined ratio than the minimum traveling electric power.

The output upper limit Wout in the second treatment for a farm field may be set to a value different from the necessary electric power. The output upper limit Wout can be set to a necessary value according to details of the second treatment. The details of the second treatment for a farm field are not limited to the example described above in the embodiment. Only two of three pieces of details performed in the embodiment may be performed or only one thereof may be performed. A treatment different from the details performed in the embodiment may be performed. The second treatment for a farm field may have details different from the first treatment for a farm field as long as it can appropriately handle an abnormality in the farm field.

The details of the first treatment for a farm field are not limited to the example described above in the embodiment. For example, limiting of the output of the battery 77 may be performed as the first treatment. The first treatment for a farm field has only to handle an abnormality of the battery 77.

In both of the first treatment and the second treatment for a farm field, the output of the battery 77 may be limited. In this case, the output upper limit Wout in the second treatment can be set to be less than that in the first treatment. In an example of such an aspect, the output upper limit Wout in the second treatment can be set as the minimum traveling electric power, and the output upper limit Wout in the first treatment can be set as the necessary electric power.

In the embodiment, when the second condition has been satisfied, the first treatment for a farm field is cancelled and the second treatment for a farm field is performed. However, when the second condition has been satisfied, the first treatment may be continuously performed and the second treatment may be performed.

The method of setting the output upper limit Wout in the normal second treatment is not limited to the example described above in the embodiment. The output upper limit Wout may be set to be greater than the minimum traveling electric power or may be set to be or less than the minimum traveling electric power. The tractor 10 can be towed on a paved road. Accordingly, even when the output upper limit Wout is set to be less than the minimum traveling electric power, it is possible to tow the tractor 10 to a repair shop.

The details of the normal second treatment are not limited to the example described above in the embodiment. The normal second treatment has only to appropriately handle an abnormality outside a farm field. Similarly, the details of the normal first treatment are not limited to the example described above in the embodiment.

Similarly to the first treatment for a farm field, the normal first treatment may be continuously performed when the second condition has been satisfied. The details of the first to fourth messages are not limited to the example described above in the embodiment. The messages have only to include details suitable for notifying an occupant of the states of the battery 77.

The notification method in the first treatment and the second treatment for a farm field is not limited to the example described above in the embodiment. For example, voice guidance of details of a message displayed on the display 15 may be performed instead of or in addition to displaying the message on the display 15. In this case, a speaker which is a notification device for performing notification using sound can be provided in the tractor 10. The speaker can be controlled as a control target by the control device 100.

As the notification method in the first treatment and the second treatment for a farm field, for example, notification using an alarm lamp may be performed. In this case, an alarm lamp can be provided as a notification device for performing notification using light. The alarm lamp can be controlled as a control target by the control device 100. For example, by setting colors of the alarm lamp which is turned on in the first treatment and the second treatment to be different, it is possible to allow an occupant to ascertain different states. This notification using the alarm lamp may be performed along with at least one of message display and voice guidance or notification using only the alarm lamp may be performed.

As the notification method in the first treatment and the second treatment for a farm field, for example, notification using a buzzer may be performed. In this case, as in the modified example of the voice guidance, a speaker which is a notification device can be provided in the tractor 10. Similarly to the modified example in which the alarm lamp is used, it is possible to allow an occupant to ascertain different states, for example, by setting tones in the first treatment and the second treatment to be different. This notification using the buzzer may be performed along with at least one of message display, voice guidance, and notification using an alarm lamp or notification using only the buzzer may be performed.

Different notification devices may be used in the first treatment and the second treatment for a farm field. The modified examples of the notification method in the first treatment and the second treatment for a farm field may be applied as a notification method in the normal first treatment and the normal second treatment.

Different notification devices may be used in the first treatment for a farm field and the normal first treatment. The same is true of the second treatment for a farm field and the normal second treatment. The first condition and the second condition are not limited to the example described above in the embodiment. For example, the first condition may be determined based on the battery temperature 93T. In this case, for example, a condition that the battery temperature 93T is equal to or higher than a first temperature may be set as the first condition, and a condition that the battery temperature 93T is equal to or higher than the second temperature may be set as the second condition. The second temperature is higher than the first temperature. By setting the first temperature to a value at which there is a doubt about an abnormality of the battery 77 and setting the second temperature to a value at which there is a high likelihood that an abnormality is occurring in the battery 77, it is possible to handle a sign of an abnormality and occurrence of the abnormality in the same way as in the aforementioned embodiment. Even when the first condition and the second condition are changed from those in the aforementioned embodiment, the second condition has only to be determined as a condition indicating occurrence of an abnormality. The first condition has only to be a condition that is satisfied when the second condition has been satisfied and that is satisfied in some situations in which the second condition has not been satisfied.

The first condition and the second condition may be defined based on different parameters. For example, the first condition may be set to a condition based on the state of charge SOC of the battery 77 and the second condition may be set to a condition based on the battery temperature 93T. The first condition and the second condition may be defined in combination of a plurality of parameters. As long as the first condition is satisfied when the second condition has been satisfied and the first condition is satisfied in some situations in which the second condition has not been satisfied, the first condition and the second condition may not employ the same parameter.

An abnormality detection object is not limited to the battery 77. Any component may be used as an abnormality detection object as long as it is a component in the electrical system between the battery 77 and the first electric motor 41. For example, the positive electrode line 81 may be used as the abnormality detection object. When the abnormality detection object is changed from that in the aforementioned embodiment, a parameter required for detecting an abnormality in the detection object has only to be detected or estimated by a sensor. The first condition and the second condition have only to be defined based on the parameter. For example, when an abnormality of the positive electrode line 81 is detected, the temperature of the positive electrode line 81 is considered to be a parameter for detecting the abnormality.

In the aforementioned embodiment, the condition for performing the first treatment for a farm field and the condition for performing the normal first treatment are the same. However, these conditions may be different. The same is true of the condition for performing the second treatment for a farm field and the condition for performing the normal second treatment.

The method of ascertaining whether the tractor 10 is located in a farm field is not limited to the method using the position information switch 51. For example, GPS position information and map information may be used. In this case, a GPS receiver may be provided in the tractor 10 and the map information may be stored in the control device 100.

A processor serving as the abnormality detection device may be provided separately from the control device 100. In this case, the abnormality detection device has only to be able to perform the abnormality handling process and control the notification device, the working machine 20, and the lifting mechanism 30 as control targets.

The entire configuration of the tractor 10 is not limited to the example described above in the embodiment. The configuration of the lifting mechanism 30 may be modified. For example, a mechanical mechanism that converts a rotational motion of the third electric motor 43 to a translational motion may be employed instead of the hydraulic device 35 in the lifting mechanism 30. The mechanical mechanism can be connected to the arms 32.

The configuration of the working machine 20 may be modified. The working machine 20 is not particularly limited as long as it is a machine operating with a torque from the PTO 25. The number of electric motors may be modified. For example, when various configurations in the embodiment are modified such that the second electric motor 42 takes charge of driving the lifting mechanism 30, the third electric motor 43 may be omitted.

What is claimed is:

1. A tractor comprising:
an electric motor configured to serve as a drive source;
a vehicle body configured to be able to be connected to a working machine and that travels with a driving force from the electric motor;
a battery configured to supply electric power to the electric motor; and
an abnormality detection device configured to detect an abnormality of an electrical system between the battery and the electric motor,
wherein the abnormality detection device is configured to perform:
a determination process of determining whether the vehicle body is located in a farm field;
a first handling process of performing a first treatment for handling the abnormality when it is determined in the determination process that the vehicle body is located in the farm field and a predetermined first condition has been satisfied; and
a second handling process of performing a second treatment different from the first treatment as a treatment for handling the abnormality when it is determined in the determination process that the vehicle body is located in the farm field and a predetermined second condition has been satisfied as a condition indicating occurrence of the abnormality, and
wherein the first condition is a condition that is satisfied when the second condition has been satisfied and that is satisfied in some situations in which the second condition has not been satisfied.

2. The tractor according to claim 1, further comprising:
a notification device configured to perform notification using at least one of light and sound;
the working machine connected to the vehicle body; and
a lifting mechanism configured to lift and lower the working machine,
wherein the abnormality detection device controls the lifting mechanism such that the lifting mechanism is in one of a lowered state in which the working machine is located at a position in contact with a ground surface and a lifted state in which the working machine is located at a position separated from the ground surface, and
wherein the abnormality detection device is configured to:
cause the notification device to notify of occurrence of the abnormality as the first treatment; and
cause the working machine to be switched to a stopped state and the lifting mechanism to be switched to the lifted state as the second treatment.

3. The tractor according to claim 1, further comprising a notification device configured to perform notification using at least one of light and sound,
wherein the abnormality detection device is configured to:
cause the notification device to notify of occurrence of the abnormality as the first treatment; and,
as the second treatment, cause an output of the battery to be limited to less than the output of the battery in a state in which the second treatment has not been performed.

4. The tractor according to claim 3, wherein the abnormality detection device is configured to store necessary electric power which is electric power per unit time required for moving over a boundary between the farm field and a road near the farm field from the farm field to the road in advance, and
wherein the abnormality detection device is configured to limit the necessary electric power to an upper limit of electric power which is able to be output from the battery per unit time as the second treatment.

5. The tractor according to claim 3, wherein the abnormality detection device is configured to prohibit execution of the second treatment when a travel speed of the vehicle body is equal to or lower than a prescribed vehicle speed.
